(19) United States
(12) Patent Application Publication
(10) Pub. No.: US 2010/0315393 A1
(43) Pub. Date: Dec. 16, 2010

(54) PLASMA DISPLAY DEVICE

(75) Inventor: Tae-Kyoung KANG, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Suwon-si (KR)

(21) Appl. No.: 12/712,679

(22) Filed: Feb. 25, 2010

(30) Foreign Application Priority Data
Jun. 15, 2009 (KR) 10-2009-0052979

(51) Int. Cl. G06F 3/038; G09G 3/28

(52) U.S. Cl. 345/205; 345/66

(57) ABSTRACT

A plasma display device with improved heat dissipation performance of a driver integrated circuit is disclosed. In one embodiment, the plasma display device includes i) plasma display panel configured to display an image, iii) a printed circuit board assembly, iii) a flexible printed circuit configured to electrically connect the printed circuit board assembly to the plasma display panel, wherein the flexible printed circuit comprises a metal layer and iv) a driver integrated circuit mounted in the flexible printed circuit and configured to control an electrode formed in the plasma display panel. The driver integrated circuit comprises: i) a base, ii) a plurality of output terminals connected to the base, and iii) a heat-conducting layer contacting 1) at least one of the plurality of output terminals and 2) the metal layer of the flexible printed circuit, wherein the heat-conducting layer and the metal layer are at least partially embedded in the flexible printed circuit.

### RELATED APPLICATIONS

This application claims priority to and the benefit of Korean Patent Application No. 10-2009-0052979 filed in the Korean Intellectual Property Office on Jun. 15, 2009, the entire contents of which are incorporated herein by reference.

### BACKGROUND

1. Field

The described technology relates generally to a plasma display device with a driver integrated circuit.

2. Description of the Related Technology

In general, a plasma display device includes a plasma display panel (PDP), a chassis base for supporting the plasma display panel, and a plurality of printed circuit board assemblies (PBAs) mounted on the chassis base.

The plasma display panel displays an image using red (R), green (G), and blue (B) visible light created by exciting phosphors using vacuum ultraviolet (VUV) rays emitted from plasma generated by gas discharge.

The above information disclosed in this Background section is only for enhancement of understanding of the background of the described technology and therefore it may contain information that does not form the prior art that is already known in this country to a person of ordinary skill in the art.

### SUMMARY OF CERTAIN INVENTIVE ASPECTS

An exemplary embodiment of the present invention provides a plasma display device representing improved heat dissipation performance of a driver integrated circuit.

Another embodiment of the present invention provides a plasma display device that reduces cost and processes.

A plasma display device in accordance with an exemplary embodiment of the present invention includes: a plasma display panel displaying an image; a plate-shaped chassis base supporting the plasma display panel with one side thereof; a printed circuit board assembly mounted on the other side of the chassis base at the opposite side of the plasma display panel; a flexible printed circuit electrically connecting the printed circuit board assembly to the plasma display panel; and a driver integrated circuit mounted in the flexible printed circuit and controlling an electrode formed in the plasma display panel, wherein the driver integrated circuit includes a silicon portion forming an integrated circuit, a plurality of output terminals connected to the silicon portion, and a heat-conducting layer interposed between at least one of the plurality of output terminals and a metal layer of the flexible printed circuit such that both sides thereof are brought into contact with the output terminal and the metal layer.

The metal layer may be formed any one of copper and aluminum foil. The heat-conducting layer may be formed of gold having excellent heat conduction.

The output terminal may include a first output terminal generating higher heat and a second output terminal generating lower heat than that of the first output terminal.

The first output terminal may be disposed around an outer periphery of the silicon portion, and the second output terminal may be disposed inside of the silicon portion.

Both sides of the heat-conducting layer may be brought into contact with the first output terminal and the metal layer. The metal layer may have a larger area than that of the first output terminal. The metal layer may further extend from the first output terminal to the center of the silicon portion. The outer periphery of the first output terminal may coincide with the outermost periphery of the silicon portion.

Both sides of the heat-conducting layer may be brought into contact with the second output terminal and the metal layer.

The metal layer may include first and second metal layers that are electrically insulated from each other, and the heat-conducting layer may include a first heat-conducting layer of which both sides are brought into contact with the first output terminal and the first metal layer, and a second heat-conducting layer of which both sides are brought into contact with the second output terminal and the second metal layer.

The metal layer may be brought into contact with the chassis base with a film of the flexible printed circuit interposed therebetween.

The output terminal may include a first output terminal generating higher heat and a second output terminal generating lower heat than that of the first output terminal, wherein the first output terminal may be disposed around an outer periphery of the silicon portion and the second output terminal may be disposed inside of the silicon portion.

Both sides of the heat-conducting layer may be brought into contact with the first output terminal and the metal layer. The metal layer may have a larger area than that of the first output terminal. The metal layer may further extend from the first output terminal to the center of the silicon portion. The outer periphery of the first output terminal may coincide with the outermost periphery of the silicon portion.

Both sides of the heat-conducting layer may be brought into contact with the second output terminal and the metal layer.

The metal layer may include first and second metal layers that are electrically insulated from each other, and the heat-conducting layer includes a first heat-conducting layer of which both sides are brought into contact with the first output terminal and the first metal layer, and a second heat-conducting layer of which both sides are brought into contact with the second output terminal and the second metal layer, wherein the first metal layer and the second metal layer may be brought into contact with the chassis base with the film of the flexible printed circuit interposed therebetween. Another aspect of the invention is a plasma display device comprising: a plasma display panel configured to display an image; a chassis base configured to support the plasma display panel with a first side thereof; a printed circuit board assembly mounted on a second side of the chassis base, wherein the second side is opposed to the first side; a flexible printed circuit configured to electrically connect the printed circuit board assembly to the plasma display panel, wherein the flexible printed circuit comprises a metal layer; and a driver integrated circuit mounted in the flexible printed circuit and configured to control an electrode formed in the plasma display panel, wherein the driver integrated circuit comprises: a silicon portion forming an integrated circuit, a plurality of output terminals connected to the silicon portion, and a heat-conducting layer comprising first and second surfaces opposing each other, wherein the first surface of the heat-conducting layer contacts at least one of the plurality of output terminals, and wherein the second surface of the heat-conducting layer contacts the metal layer of the flexible printed circuit.

In the above device, the metal layer is formed of at least one of copper and aluminum foil. In the above device, the first surface of the heat-conducting layer is closer to the silicon portion than the second surface of the heat-conducting layer. In the above device, the output terminals comprise: a first output terminal configured to generate a first amount of heat, and a second output terminal configured to generate a second amount of heat than which is less than the first amount of heat.

In the above device, the first output terminal is disposed around an outer periphery of the silicon portion, and wherein the second output terminal is closer to the center of the silicon portion than the first output terminal. In the above device, the first and second surfaces of the heat-conducting layer contact the first output terminal and the metal layer, respectively. In the above device, the metal layer has a larger area than that of the first output terminal.

In the above device, the metal layer comprises first, second and third portions which are integrally formed into one unit, wherein the second portion contacts the first output terminal, wherein the first and third portions do not contact the first output terminal, wherein the first portion extends toward the center of the silicon portion and wherein the third portion extends away from the center of the silicon portion. In the above device, the outer periphery of the first output terminal substantially coincides with the outermost periphery of the silicon portion. In the above device, the first and second surfaces of the heat-conducting layer contact the second output terminal and the metal layer, respectively.

In the above device, the metal layer comprises first and second sub-metal layers that are electrically insulated from each other, wherein the heat-conducting layer comprises first and second sub-heat-conducting layers separated from each other, wherein each of the first and second sub-heat-conducting layers comprises first and second surfaces opposing each other, wherein the first and second surfaces of the first sub-heat-conducting layer contact the first output terminal and the first sub-metal layer, respectively and wherein the first and second surfaces of the second sub-heat-conducting layer contact the second output terminal and the second sub-metal layer, respectively.

The above device further comprises a film formed in the flexible printed circuit, wherein the film is interposed between the metal layer and the chassis base, and wherein the film contacts the chassis base. In the above device, the output terminals comprise: a first output terminal configured to generate a first amount of heat and a second output terminal configured to generate a second amount of heat which is less than the first amount of heat, wherein the first output terminal is disposed around an outer periphery of the silicon portion, and wherein the second output terminal is closer to the center of the silicon portion than the first output terminal.

In the above device, the first and second surfaces of the heat-conducting layer contact the first output terminal and the metal layer, respectively. In the above device, the metal layer comprises first, second and third portions which are integrally formed into one unit, wherein the second portion contacts the first output terminal, wherein the first and third portions do not contact the first output terminal, wherein the first portion extends toward the center of the silicon portion and wherein the third portion extends away from the center of the silicon portion.

In the above device, the metal layer comprises: first and second sub-metal layers that are electrically insulated from each other, and wherein the heat-conducting layer comprises: first and second sub-heat-conducting layers separated from each other, wherein each of the first and second sub-heat-conducting layers comprises first and second surfaces opposing each other, wherein the first and second surfaces of the first sub-heat-conducting layer contact the first output terminal and the first sub-metal layer, respectively and wherein the first and second surfaces of the second sub-heat-conducting layer contact the second output terminal and the second sub-metal layer, respectively, wherein the film of the flexible printed circuit is interposed between i) the first sub-metal layer and the second sub-metal layer and ii) the chassis base, wherein the film contacts the chassis base.

In the above device, the metal layer and the heat-conducting layer are at least partially embedded in the flexible printed circuit. In the above device, the metal layer is substantially completely embedded in the flexible printed circuit.

Another aspect of the invention is a plasma display device comprising: a plasma display panel configured to display an image; a printed circuit board assembly; a flexible printed circuit configured to electrically connect the printed circuit board assembly to the plasma display panel, wherein the flexible printed circuit comprises a metal layer; and a driver integrated circuit mounted in the flexible printed circuit and configured to control an electrode formed in the plasma display panel, wherein the driver integrated circuit comprises: a base; a plurality of output terminals connected to the base, and a heat-conducting layer contacting i) at least one of the plurality of output terminals and ii) the metal layer of the flexible printed circuit, wherein the heat-conducting layer and the metal layer are at least partially embedded in the flexible printed circuit.

In the above device, the metal layer is substantially completely embedded in the flexible printed circuit.

### BRIEF DESCRIPTION OF THE DRAWINGS

FIG. 1 is an exploded perspective view schematically showing a plasma display device in accordance with a first exemplary embodiment of the present invention.

FIG. 2 is a cross-sectional view taken along line II-II of FIG. 1.

FIG. 3 is a cross-sectional view showing a heat dissipation structure of a driver integrated circuit in a plasma display device and a TCP used therein in accordance with the first exemplary embodiment.

FIGS. 4 to 6 are cross-sectional views showing heat dissipation structures of driver integrated circuits in plasma display devices and TCPs used therein in accordance with second to fourth exemplary embodiments.

FIGS. 7 to 10 are cross-sectional views showing heat dissipation structures of driver integrated circuits in plasma display devices and TCPs used therein in accordance with fifth to eighth exemplary embodiments.

### DETAILED DESCRIPTION OF CERTAIN INVENTIVE EMBODIMENTS

Among the printed circuit board assemblies, an address buffer board assembly is mounted on the chassis base at the opposite side of the plasma display panel and connected to address electrodes, formed in the plasma display panel, through a flexible printed circuit (FPC), thus controlling the address electrodes.

The flexible printed circuit is equipped with a driver integrated circuit to form a driver integrated circuit package and, for example, the flexible printed circuit may form a tape carrier package (TCP). One end of the flexible printed circuit is connected to the address electrodes and the other end thereof is connected to the address buffer board assembly.

With an increase in size and resolution of the plasma display panel, the driver integrated circuit for driving discharge cells increases the number of switching times and is implemented with a multichannel structure to reduce the cost, thereby generating a considerable amount of heat.

For example, in the plasma display device, the driver integrated circuit is brought into contact with the chassis base and covered by a cover plate, and a thermal grease and a heat dissipating member are provided on both sides of the driver integrated circuit.

Therefore, heat generated by the driver integrated circuit is conducted to the chassis base and the cover plate provided on both sides of the driver integrated circuit and then dissipated. This structure increases cost and processes due to additional elements such as the cover plate and the heat dissipating member.

Hereinafter, embodiments of the present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

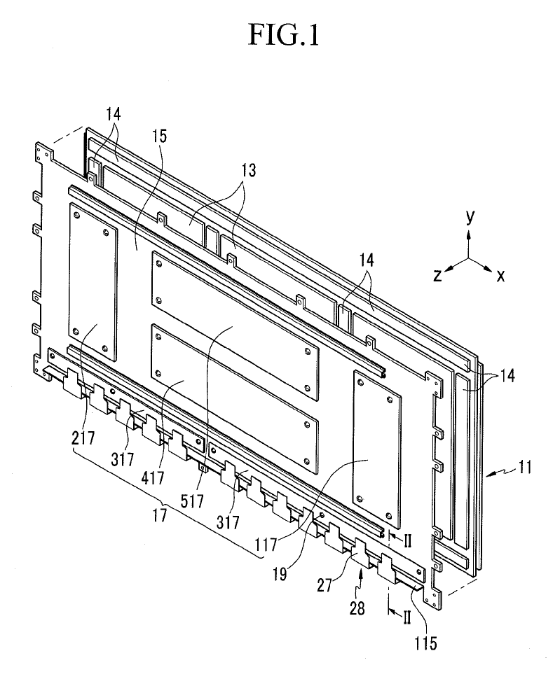

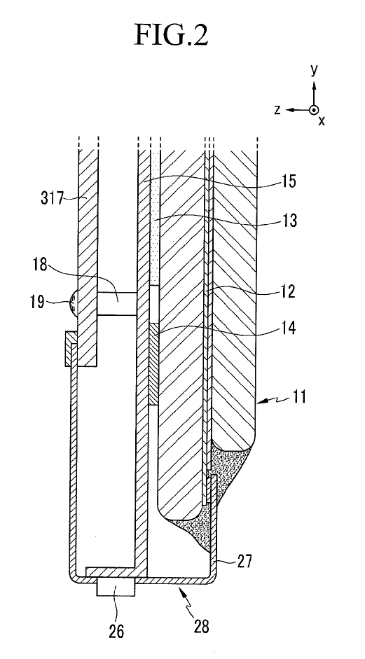

FIG. 1 is an exploded perspective view schematically showing a plasma display device in accordance with a first exemplary embodiment of the present invention, and FIG. 2 is a cross-sectional view taken along line II-II of FIG. 1.

Referring to FIGS. 1 and 2, the plasma display device includes i) a plasma display panel (PDP) 11 displaying an image using gas discharge, ii) a plurality of heat dissipation sheets 13 dissipating heat generated in the plasma display panel 11, iii) a chassis base 15, and iv) a plurality of printed circuit board assemblies (PBAs) 17.

In one embodiment, the chassis base 15 is indirectly attached to the rear surface of the plasma display panel 11 by double-sided adhesive tape 14 with the heat dissipation sheets 13 interposed between the chassis base 15 and the plasma display panel 11, and supports the plasma display panel 11.

The printed circuit board assemblies 17 are mounted on the rear surface of the chassis base 15. For example, the printed circuit board assemblies 17 are placed on a plurality of bosses 18 provided on the chassis base 15 and fixedly mounted on the chassis base 15 by tightening setscrews 19.

Moreover, the printed circuit board assemblies 17 are configured to drive the plasma display panel 11 and are connected to the plasma display panel 11 through flexible printed circuits (FPCs) 27.

The plasma display panel 11 includes electrodes for generating gas discharge in discharge cells (not shown), such as a sustain electrode (not shown), a scan electrode (not shown), and an address electrode 12. Therefore, each of the plurality of printed circuit board assemblies 17 performs its function of driving the electrodes of the plasma display panel 11.

For example, the printed circuit board assemblies 17 includes a sustain board assembly 117 controlling the sustain electrode (not shown), a scan board assembly 217 controlling a scan electrode (not shown), and an address buffer board assembly 317 controlling the address electrode 12.

Therefore, the sustain board assembly 117 is connected to the sustain electrode through a flexible printed circuit (not shown), the scan board assembly 217 is connected to the scan electrode through a flexible printed circuit (not shown), and the address buffer board assembly 317 is connected to the address electrode 12 through the flexible printed circuit 27.

Moreover, the printed circuit board assemblies 17 further include an image processing/controlling board assembly 417, which receives a video signal from the outside, generates control signals for driving the address electrode 12, the sustain electrode, and the scan electrode, and applies the control signals to the corresponding board assemblies, and a power supply board assembly 517, which provides electrical power for driving the respective board assemblies.

In one embodiment, the flexible printed circuits 27 electrically connect the printed circuit board assemblies 17 to the plasma display panel 11. Another embodiment of the present invention may include a flexible printed circuit (not shown) equipped with a scan integrated circuit (not shown) and connected to the scan board assembly 217, and a flexible printed circuit 27 equipped with a driver integrated circuit 26 and connected to the address buffer board assembly 317.

For convenience, exemplary embodiments will be described with reference to the flexible printed circuit 27 equipped with the driver integrated circuit 26. Substantially, the flexible printed circuit 27 and the driver integrated circuit 26 may form a tape carrier package (TCP) 28.

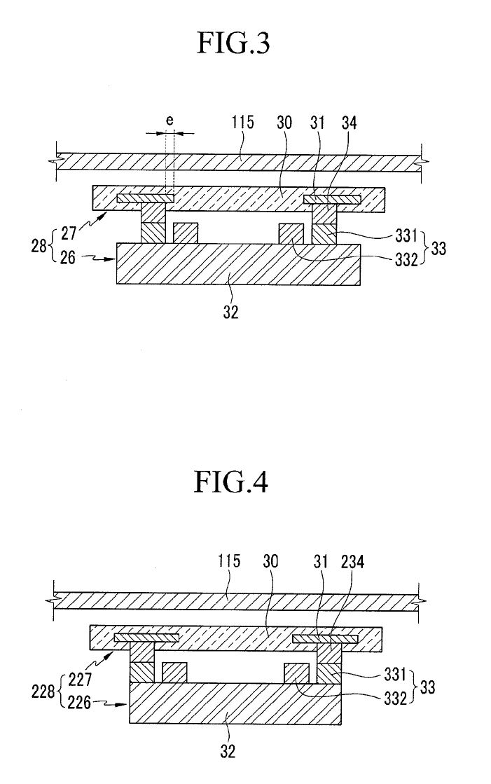

FIG. 3 is a cross-sectional view showing a heat dissipation structure of the driver integrated circuit in the plasma display device and the TCP used therein in accordance with the first exemplary embodiment.

Referring to FIG. 3, a TCP 28 or flexible printed circuit 27 forms a pattern with a metal layer 31 within a film 30, and is spaced from the chassis base 15 to be thermally separated therefrom. In one embodiment, the metal layer 31 is also thermally separated from the chassis base 15. In this embodiment, heat generated in the driver integrated circuit 26 is not conducted to the chassis base 15 but is dissipated from the flexible printed circuit 27 through the metal layer 31.

In the flexible printed circuit 27, the metal layer 31 applies electrical power to the driver integrated circuit 26. The metal layer 31 may be made of various patterns and materials according to the structure in which the metal layer 31 is connected to the driver integrated circuit 26. For example, the metal layer 31 may be formed of at least one of copper (Cu) and aluminum (Al) foil.

The driver integrated circuit 26 includes a silicon portion (or a base) 32 forming an integrated circuit, a plurality of output terminals 33 connected to the silicon portion 32 and protruding to the outside of the silicon portion 32, and a heat-conducting layer 34 connected to at least one of the plurality of output terminals 33. That is, according to the first exemplary embodiment of the present invention, the TCP 28 includes the driver integrated circuit 26 having the heat-conducting layer 34 and the flexible printed circuit 27 in which the driver integrated circuit 26 is mounted.

The heat-conducting layer 34 is interposed between the output terminal 33 and the metal layer 31 such that both sides thereof are brought into contact with the output terminal 33 and the metal layer 31. Moreover, the heat-conducting layer 34 may be formed of a material having excellent heat conduction and, for example, may be formed of gold (Au). Therefore, the heat-conducting layer 34 transmits heat generated in the output terminal 33 to the metal layer 31 of the flexible printed circuit 27 to be dissipated, thus improving heat dissipation performance of the driver integrated circuit 26.

The output terminal 33 includes a first output terminal 331 generating high heat and a second output terminal 332 generating lower heat than that of the first output terminal 331. For example, the first output terminal 331 (e.g., Vpp output terminal) is connected to the address electrode 12 through a signal line (not shown) of the flexible printed circuit 27 to output a control signal of the address electrode 12. In one embodiment, the second output terminal 332 (e.g., Npp output terminal) is grounded to the address buffer board assembly 317 through a signal line (not shown) of the flexible printed circuit 27.

In one embodiment, the signal lines to which the first and second output terminals 331 and 332 are connected are electrically insulated from each other. One of the signal lines corresponds to the metal layer 31 connected to the heat-conducting layer 34.

Since the first output terminal 331 generates higher heat than that of the second output terminal 332, the first output terminal 331 is disposed around the outer periphery of the silicon portion 32 to be brought into contact with the air, thus accelerating heat dissipation. Since the second output terminal 332 generates lower heat than that of the first output terminal 331, the second output terminal 332 is disposed inside of the silicon portion 32. As a result, it is possible to improve the overall heat dissipation performance of the driver integrated circuit 26.

Referring to FIG. 3, the heat-conducting layer 34 is interposed between the first output terminal 331 and the metal layer 31 such that one side thereof is brought into contact with the first output terminal 331 and the other side is brought into contact with the metal layer 31. Therefore, in the TCP 28 in accordance with the first exemplary embodiment, the heat-conducting layer 34 conducts the heat generated in the first output terminal 331 to the metal layer 31 to be dissipated therefrom.

The metal layer 31 has a larger area than that of the first output terminal 331 brought into contact therewith. Therefore, the metal layer 31 can rapidly dissipate the heat of the first output terminal 331 conducted through the heat-conducting layer 34. For example, to form a larger heat dissipation area, the metal layer 31 may be formed with a maximum size to the outside of the silicon portion 32 within the available range of the flexible printed circuit 27. The metal layer 31 may further extend (e) from the first output terminal 331 to the center of the silicon portion 32 as shown in FIG. 3.

As such, in the first exemplary embodiment, the high heat of the first output terminal 331 is transmitted to the metal layer 31 by way of the heat-conducting layer 34, and the low heat of the second output terminal 332 is naturally dissipated to the air.

Therefore, in the first exemplary embodiment, the TCP 28 effectively dissipates the heat from the driver integrated circuit 26 and the first output terminal 331, and thereby no additional cost or process is required to dissipate the heat of the driver integrated circuit 26 in the plasma display device.

Next, various exemplary embodiments of the present invention will be described, in which descriptions of the same or similar elements as those described in the first exemplary embodiment and previous exemplary embodiments will be omitted, and only different elements will be described.

FIGS. 4 to 6 are cross-sectional views showing heat dissipation structures of driver integrated circuits in plasma display devices and TCPs used therein in accordance with second to fourth exemplary embodiments.

In the TCP 28 of the first exemplary embodiment, the first output terminal 331 is disposed around the outer periphery of the silicon portion 32. Compared to this, in a TCP 228 of a second exemplary embodiment shown in FIG. 4, the outer periphery of a first output terminal 331 substantially coincides with the outermost periphery of a silicon portion 32. In this state, a heat-conducting layer 234 is interposed between a metal layer 31 of a flexible printed circuit 227 and the first output terminal 331 such that both sides thereof are brought into contact therewith. Therefore, compared to the first exemplary embodiment, the second exemplary embodiment further improves the heat dissipation performance of a driver integrated circuit 226 and the first and second output terminals 331 and 332.

In the TCP 28 of the first exemplary embodiment, the heat-conducting layer 34 is disposed between the first output terminal 331 and the metal layer 31. Compared to this, in a TCP 328 of a third exemplary embodiment shown in FIG. 5, a heat-conducting layer 334 is provided between a metal layer 31 of a flexible printed circuit 327 and a second output terminal 332. Both sides of the heat-conducting layer 334 are brought into contact with the second output terminal 332 and the metal layer 31 to conduct the heat generated in the second output terminal 332 to the metal layer 31 to be dissipated.

In the first exemplary embodiment, the first output terminal 331 is disposed around the outer periphery of the silicon portion 32, and the heat-conducting layer 34 is provided so as to intensively dissipate heat from the first output terminal 331. Compared to this, in the third exemplary embodiment, the first output terminal 331 is disposed around the outer periphery such that the heat can be naturally dissipated from the first output terminal 331 by the air. Further, the heat-conducting layer 334 is provided on the second output terminal 332 disposed on the inside and having weak heat dissipation performance, thus improving the heat dissipation performance of a driver integrated circuit 326 and the second output terminal 332.

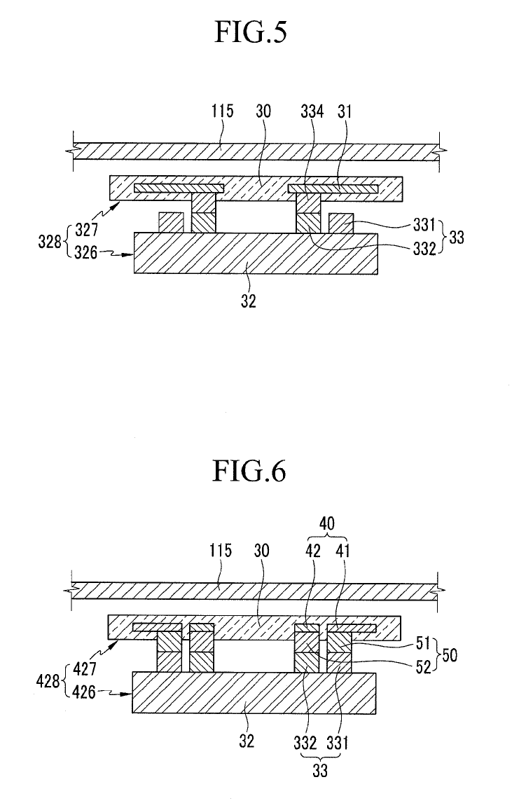

In the TCP 28 of the first exemplary embodiment, only one of each of the heat-conducting layer 34 and the metal layer 31 is provided, and the heat-conducting layer 34 is disposed between the first output terminal 331 and the metal layer 31. Compared to this, in a TCP 428 of a fourth exemplary embodiment shown FIG. 6, a metal layer 40 includes first and second metal layers 41 and 42, which are electrically insulated from each other, and a heat-conducting layer 50 includes first and second heat-conducting layers 51 and 52.

Moreover, the first heat-conducting layer 51 is interposed between the first metal layer 41 of a flexible printed circuit 427 and a first output terminal 331 such that both sides thereof are brought into contact therewith. In addition, the second heat-conducting layer 52 is interposed between the second metal layer 42 of the flexible printed circuit 427 and a second output terminal 332 such that both sides thereof are brought into contact therewith.

In the first exemplary embodiment, the heat generated in the first output terminal 331 is transmitted to the metal layer 31 through the heat-conducting layer 34. Compared to this, in the fourth exemplary embodiment, the heat generated in a driver integrated circuit 426 and the first output terminal 331 is transmitted to the first metal layer 41 through the first heat-conducting layer 51. Further, the heat generated in the driver integrated circuit 426 and the second output terminal 332 is transmitted to the second metal layer 42 through the second heat-conducting layer 52.

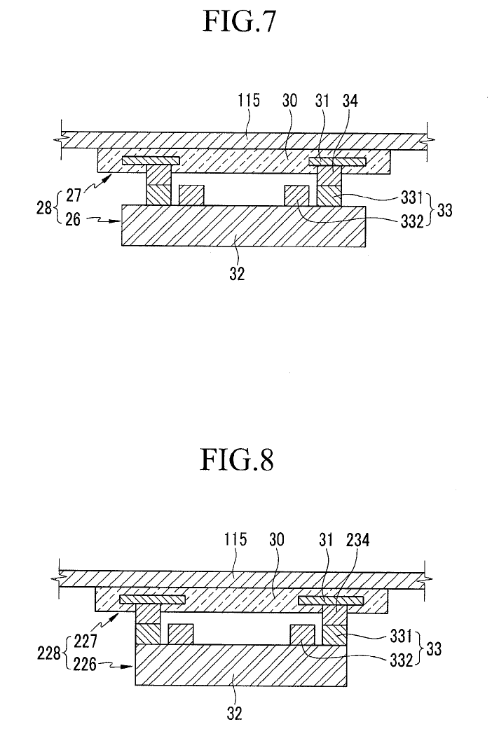

Each of the TCPs 28 and 228 of the first and second exemplary embodiments is separated from the chassis base 15 to transmit the heat generated in the first output terminal 331 to the metal layer 31 through the heat-conducting layer 34. Compared to this, each of TCPs 28 and 228 in accordance with fifth and sixth exemplary embodiments shown in FIGS. 7 and 8 are brought into contact with a bent portion 115 of a chassis base 15 to transmit the heat to the chassis base 15.

In the fifth and sixth exemplary embodiments, a metal layer 31 is brought into contact with the bent portion 115 of the chassis base 15 with a film 30 of each of flexible printed circuits 27 and 227 interposed therebetween. Therefore, heat generated in driver integrated circuits 26 and 226 and a first output terminal 331 is conducted to the metal layer 31 through heat-conducting layers 34 and 234, conducted to the bent portion 115 of the chassis base 15 through the film 30, and dissipated to the outside.

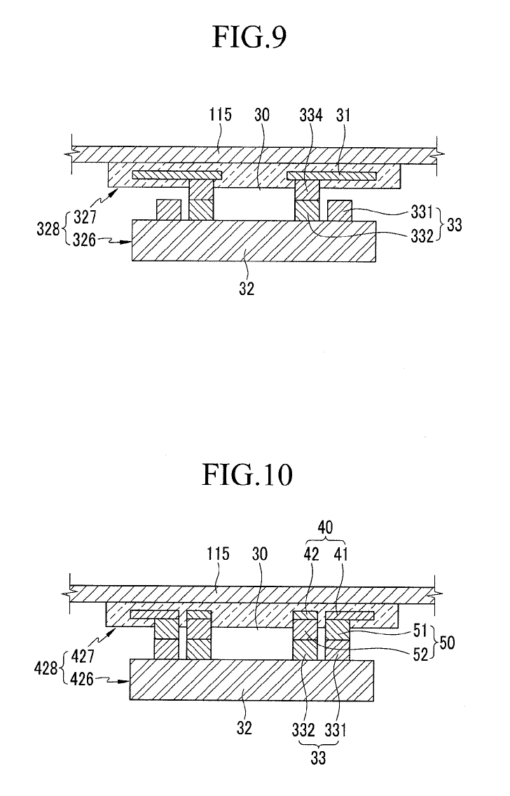

The TCP 328 of the third exemplary embodiment is separated from the chassis base 15 to transmit the heat generated in the driver integrated circuit 326 and the second output terminal 332 to the metal layer 31. Compared to this, a TCP 328 in accordance with a seventh exemplary embodiment shown in FIG. 9 is brought into contact with a bent portion 115 of a chassis base 15 to transmit to the chassis base 15.

In the seventh exemplary embodiment, a metal layer 31 is brought into contact with the bent portion 115 of the chassis base 15 with a film 30 of a flexible printed circuit 327 interposed therebetween. Therefore, heat generated in a driver integrated circuit 326 and a second output terminal 332 is conducted to the metal layer 31 through a heat-conducting layer 334, conducted to the bent portion 115 of the chassis base 15 through the film 30, and dissipated to the outside.

The TCP 428 of the fourth exemplary embodiment is separated from the chassis base 15 to transmit the heat generated in the first and second output terminals 331 and 332 to the first and second metal layers 41 and 42 through the first and second heat-conducting layers 51 and 52. Compared to this, a TCP 428 in accordance with an eighth exemplary embodiment shown in FIG. 10 is brought into contact with a bent portion 115 of a chassis base 15 to transmit heat to the chassis base 15.

In the eighth exemplary embodiment, first and second metal layers 41 and 42 are brought into contact with the bent portion 115 of the chassis base 15 with a film 30 of a flexible printed circuit 427 interposed therebetween. Therefore, heat generated in a driver integrated circuit 426 and first and second output terminals 331 and 332 is conducted to the first and second metal layers 41 and 42 through first and second heat-conducting layers 51 and 52, is conducted to the bent portion 115 of the chassis base 15 through the film 30, and is dissipated to the outside.

As such, according to at least one embodiment of the present invention, since a heat-conducting layer having excellent heat conduction is interposed between at least one of a plurality of output terminals generating high heat and a metal layer of a flexible printed circuit applying a voltage, heat generated in the output terminal is transmitted to the metal layer by way of the heat-conducting layer and then dissipated therefrom.

According to at least one embodiment of the present invention, heat generated in the output terminal can be dissipated through the heat-conducting layer without the necessity of providing a heat dissipation member or cover plate on the outside of a driver integrated circuit, and thus it is possible to effectively dissipate heat from the driver integrated circuit and eliminate additional cost and processes.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display device comprising:
a plasma display panel configured to display an image;
a chassis base configured to support the plasma display panel with a first side thereof;
a printed circuit board assembly mounted on a second side of the chassis base, wherein the second side is opposed to the first side;
a flexible printed circuit configured to electrically connect the printed circuit board assembly to the plasma display panel, wherein the flexible printed circuit comprises a metal layer; and
a driver integrated circuit mounted in the flexible printed circuit and configured to control an electrode formed in the plasma display panel,
wherein the driver integrated circuit comprises:
a silicon portion forming an integrated circuit,
a plurality of output terminals connected to the silicon portion, and
a heat-conducting layer comprising first and second surfaces opposing each other, wherein the first surface of the heat-conducting layer contacts at least one of the plurality of output terminals, and wherein the second surface of the heat-conducting layer contacts the metal layer of the flexible printed circuit.

2. The plasma display device of claim 1, wherein the metal layer is formed of at least one of copper and aluminum foil.

3. The plasma display device of claim 1, wherein the first surface of the heat-conducting layer is closer to the silicon portion than the second surface of the heat-conducting layer.

4. The plasma display device of claim 1, wherein the output terminals comprise:
a first output terminal configured to generate a first amount of heat, and
a second output terminal configured to generate a second amount of heat than which is less than the first amount of heat.

5. The plasma display device of claim 4, wherein the first output terminal is disposed around an outer periphery of the silicon portion, and wherein the second output terminal is closer to the center of the silicon portion than the first output terminal.

6. The plasma display device of claim 5, wherein the first and second surfaces of the heat-conducting layer contact the first output terminal and the metal layer, respectively.

7. The plasma display device of claim 6, wherein the metal layer has a larger area than that of the first output terminal.

8. The plasma display device of claim 7, wherein the metal layer comprises first, second and third portions which are integrally formed into one unit, wherein the second portion contacts the first output terminal, wherein the first and third portions do not contact the first output terminal, wherein the first portion extends toward the center of the silicon portion and wherein the third portion extends away from the center of the silicon portion.

9. The plasma display device of claim 6, wherein the outer periphery of the first output terminal substantially coincides with an outermost periphery of the silicon portion.

10. The plasma display device of claim 5, wherein the first and second surfaces of the heat-conducting layer contact the second output terminal and the metal layer, respectively.

11. The plasma display device of claim 5, wherein the metal layer comprises first and second sub-metal layers that are electrically insulated from each other, wherein the heat-conducting layer comprises first and second sub-heat-conducting layers separated from each other, wherein each of the first and second sub-heat-conducting layers comprises first and second surfaces opposing each other, wherein the first and second surfaces of the first sub-heat-conducting layer contact the first output terminal and the first sub-metal layer, respectively and wherein the first and second surfaces of the second sub-heat-conducting layer contact the second output terminal and the second sub-metal layer, respectively.

12. The plasma display device of claim 1, further comprising a film formed in the flexible printed circuit, wherein the film is interposed between the metal layer and the chassis base, and wherein the film contacts the chassis base.

13. The plasma display device of claim 12, wherein the output terminals comprise: a first output terminal configured to generate a first amount of heat and
a second output terminal configured to generate a second amount of heat which is less than the first amount of heat,
wherein the first output terminal is disposed around an outer periphery of the silicon portion, and
wherein the second output terminal is closer to the center of the silicon portion than the first output terminal.

14. The plasma display device of claim 13, wherein the first and second surfaces of the heat-conducting layer contact the first output terminal and the metal layer, respectively.

15. The plasma display device of claim 14, wherein the metal layer comprises first, second and third portions which are integrally formed into one unit, wherein the second portion contacts the first output terminal, wherein the first and third portions do not contact the first output terminal, wherein the first portion extends toward the center of the silicon portion and wherein the third portion extends away from the center of the silicon portion.

16. The plasma display device of claim 13, wherein the metal layer comprises:
first and second sub-metal layers that are electrically insulated from each other, and
wherein the heat-conducting layer comprises:
first and second sub-heat-conducting layers separated from each other, wherein each of the first and second sub-heat-conducting layers comprises first and second surfaces opposing each other, wherein the first and second surfaces of the first sub-heat-conducting layer contact the first output terminal and the first sub-metal layer, respectively and wherein the first and second surfaces of the second sub-heat-conducting layer contact the second output terminal and the second sub-metal layer, respectively,
wherein the film of the flexible printed circuit is interposed between i) the first sub-metal layer and the second sub-metal layer and ii) the chassis base, wherein the film contacts the chassis base.

17. The plasma display device of claim 1, wherein the metal layer and the heat-conducting layer are at least partially embedded in the flexible printed circuit.

18. The plasma display device of claim 17, wherein the metal layer is substantially completely embedded in the flexible printed circuit.

19. A plasma display device comprising:
a plasma display panel configured to display an image;
a printed circuit board assembly;
a flexible printed circuit configured to electrically connect the printed circuit board assembly to the plasma display panel, wherein the flexible printed circuit comprises a metal layer; and
a driver integrated circuit mounted in the flexible printed circuit and configured to control an electrode formed in the plasma display panel,
wherein the driver integrated circuit comprises:
a base;
a plurality of output terminals connected to the base, and
a heat-conducting layer contacting i) at least one of the plurality of output terminals and ii) the metal layer of the flexible printed circuit, wherein the heat-conducting layer and the metal layer are at least partially embedded in the flexible printed circuit.

20. The plasma display device of claim 19, wherein the metal layer is substantially completely embedded in the flexible printed circuit.
